(19) United States
(12) Patent Application Publication
(10) Pub. No.: US 2026/0307965 A1
(43) Pub. Date: Oct. 8, 2026

(54) HANDLING MACHINE HAVING AN ARM AND CORRESPONDING CONTROL METHOD

(71) Applicant: MANITOU BF, ANCENIS (FR)

(72) Inventor: Sylvain CADOU, ANCENIS (FR)

(21) Appl. No.: 19/483,900

(22) PCT Filed: May 10, 2024
(86) PCT No.: PCT/EP2024/062967

§ 371 Date: Nov. 12, 2025

(30) Foreign Application Priority Data
May 15, 2023 (EP) 23173404.7

(51) Int. Cl. B66F 9/075

(52) U.S. Cl. CPC B66F 9/0755; B66F 9/07559

(57) ABSTRACT

The invention relates to a handling machine (1) comprising a main body (2), a handling arm (6) mounted on the main body (2) and movable relative to the main body (2) so as to rotate between a raised position and a lowered position, an actuating device (8) configured to raise and lower the handling arm (6), a tilting detector (11) configured to produce a signal, referred to as instability signal relating to a tilting moment applied to the main body (2) about a tilting axis of the handling machine, and a control unit (10) configured to control the actuating device (8). The control unit (10) is configured to determine the speed of variation of the value of the instability signal, and to generate a signal for stopping or slowing a movement of the handling arm (6), as a function of the speed of variation of the instability value and of a threshold value of the speed of variation of the instability. The invention further relates to a corresponding control method.

### FIELD OF THE INVENTION

The invention relates to the field of handling machines including a main body generally intended to be placed on the ground, at least one handling arm intended to receive a payload that has to be moved, and an actuating device configured to move the handling arm relative to the main body, and relates in particular to mobile handling machines.

Such a machine can in particular take the form of a telescopic arm truck, crane, mechanical shovel loader, bucket loader or the like.

### PRIOR ART

A known handling machine described in JP3252006 includes a machine body and a handling arm mobile relative to the machine body.

This machine is subjected to gravitational forces due to the load carried by the handling arm and the weight of the machine and inertial forces induced by the movements of the handling arm. These forces generate a tipping moment applied to the body of the machine which can cause an imbalance or even tipping of the machine if it exceeds a certain threshold.

This machine includes control means for limiting the movements of the handling arm in order to prevent such tipping of the machine.

In particular the control means slow and then halt the handling arm on approaching a position of the handling arm in which the tipping moment is above a given threshold.

This threshold varies as a function of the angle of inclination of the handling arm relative to the ground and a rate of approach to an authorized moment.

Using as a control criterion for limiting or halting the handling arm the angle of inclination of the arm and the value of the tipping moment can prove inappropriate, however.

In fact a given arm angle and a given tipping moment can be encountered in various handling operations, some of which have a higher risk of tipping than others.

The present invention has for object proposing a new handling machine enabling some or all of the problems described above to be alleviated.

### SUMMARY OF THE INVENTION

To this end the invention has for object a handling machine including:
a main body,
a handling arm mounted on said main body and rotatable relative to the main body between a raised position and a lowered position,
an actuating device configured to raise and to lower said handling arm,
a tipping detector configured to produce a signal called the instability signal relating to a tipping moment applied to the main body about a tipping axis of said handling machine, and
a control unit configured to control the actuating device,
   characterized in that said control unit is configured:
to determine the rate of variation of the value of the instability signal,
to generate a signal to halt or to slow movement of the handling arm as a function of the rate of variation of said value of the instability signal and a threshold value for the rate of variation of the instability signal.

One idea behind this invention is to provide a handling machine in which it is the rate of variation of the instability signal that is taken into account to decide whether or not to halt or to reduce the movement of the handling arm in order to take account of the dynamic context of the handling operation.

In other words, in contrast to the solution in the prior art JP3252006 which acts on the handling arm as a function of static parameters consisting of the angle of the arm and the tipping moment at a given time, the criterion used by the solution according to the invention is the rate of variation of the instability signal, that is to say the rate of variation of the tipping moment, and not the value(s) as such of the tipping moment and/or of the angle of the arm, which do not reflect the dynamic of the current operation.

In fact a value of the inclination angle of the arm and a given value of the tipping moment at a given time do not take into account the dynamic of the operation of the handling machine whereas that dynamic can have an important role in the risk of tipping of the handling machine.

Using the rate of variation of the instability signal, that is to say the speed at which the stability of the handling machine is being degraded, as the criterion for halting or restricting the movement of the arm enables more effective limitation of the risk of tipping while allowing a larger working space for the handling arm.

This rate of variation of instability effectively takes into account all the factors influencing stability such as the speed of operations by the machine, the geometric configuration of the structure and the load being handled.

In other words the handling machine allows the closest possible approach to the operating limits of the machine in terms of the working space of the handling arm in a safe manner. Furthermore this also makes it possible to prevent the machine tipping because of too great a dynamic whereas the machine would be in a configuration to which there would correspond at the given time an instability signal the value of which, as such, could let it be thought that the risk of tipping is not high, whereas sudden halting by the operator could lead to a risk of overturning.

In accordance with one advantageous feature of the invention the control unit is configured to calculate the threshold value of the rate of variation of the instability signal as a function of the value of the instability signal. According to one specific aspect the control unit is configured to calculate the threshold value of the rate of variation of the instability signal also as a function of a predefined value corresponding to a maximal rate of variation of the instability signal.

Alternatively the control unit can be configured to calculate the threshold value of the rate of variation of the instability signal as a function of a geometrical parameter of the handling machine such as the angle between the handling arm and the plane in which the main body of the handling machine bears on the ground and/or a configuration parameter of the handling machine such as the configuration with the stabilizers of the handling machine bearing on the ground or not.

In accordance with an advantageous feature of the invention said control unit is configured to compare the value of the instability signal with a predefined instability threshold value, for example 85%, and if the value of the instability signal is above or equal to said instability threshold value:
to compare said rate of variation of the value of the instability signal with the threshold value of the rate of variation of said instability signal, and
if said rate of variation of said value of the instability signal is above or equal to the threshold value of the rate of variation of said instability signal to generate said signal to halt or to slow the movement of the handling arm.

In accordance with an advantageous feature of the invention the threshold value of the rate of variation of said instability signal denoted VJ_{threshold} is calculated using the formula:

$${VJ}_{threshold} = ( {J}_{stat \_ max} - J ) * {VJ}_{max} / ( {J}_{stat \_ max} - {J}_{threshold} )$$

J_{stat_max} being a predefined value corresponding to a maximal value of the instability signal beyond which it is considered that in a static configuration of the handling machine the latter tips,
J being the value of the instability signal,
J_{threshold} being a predefined threshold value of the instability signal,
VJₘₐₓ being a predefined value corresponding to a maximal rate of variation of the instability signal.

In accordance with an advantageous feature of the invention said handling arm is a telescopic arm deployable and retractable in a longitudinal direction of said handling arm and the actuating device is also configured to deploy and to retract said handling arm.

In accordance with an advantageous feature of the invention said tipping detector includes at least one extensometer preferably arranged on an axle, for example a rear axle, of the handline machine,

and said tipping detector produces the instability signal as a function of the signal supplied by the extensometer.

In one particular embodiment the handling arm can also be oriented by rotating it about an axis orthogonal to the plane in which the handling machine bears on the ground.

In accordance with an advantageous feature of the invention the handling machine includes a warning system including warning elements such as indicator lamps switching on of which is a function of the rate of variation of the instability signal.

In accordance with an advantageous feature of the invention said signal to halt or to slow movement of the handling arm is a signal to halt or to slow a movement of lowering or extending the handling arm.

The invention also concerns a method of controlling a handling machine including a main body, a handling arm mounted on said main body and rotatable relative to the main body between a raised position and a lowered position, a tipping detector configured to produce a signal called the instability signal relating to a tipping moment applied to the main body about a tipping axis of said handling machine,

characterized in that said method includes the following steps:
determining the rate of variation of the value of the instability signal,
generating a signal to halt or to slow movement of the handling arm as a function of the rate of variation of said value of the instability signal and a threshold value for the rate of variation of the instability signal.

In accordance with an advantageous feature of the invention the threshold value of the rate of variation of the instability signal is calculated as a function of the value of the instability signal.

Alternatively the threshold value of the rate of variation of the instability signal can be calculated as a function of a geometrical parameter of the handling machine such as the angle between the handling arm and the plane in which the main body of the handline machine bears on the ground and/or a configuration parameter of the handling machine such as the configuration with the stabilizers of the handling machine bearing on the ground or not.

In accordance with an advantageous feature of the invention the method includes the following steps:
comparing said rate of variation of the value of the instability signal with the threshold value of the rate of variation of said instability signal, and
if said rate of variation of said value of the instability signal is above or equal to the threshold value of the rate of variation of said instability signal, generating said signal to halt or to slow the movement of the handling arm and otherwise to authorize continued movement of the handling arm.

### BRIEF DESCRIPTION OF THE DRAWINGS

The invention will be better understood and other aims, details, features and advantages thereof will become more clearly apparent in the course of the following description of particular embodiments of the invention given by way of non-limiting illustration only with reference to the appended drawings, in which:

FIG. 1 is a schematic representation of a handling machine;

FIG. 2 is a representation of a tipping detector that can be used in the handling machine from FIG. 1;

FIG. 3 is a schematic representation of a control method that can be executed by the handling machine from FIG. 1;

FIG. 4 is a schematic representation of another control method that can be executed by the handling machine from FIG. 1;

FIG. 4A is a schematic representation of another control method that can be executed by the handling machine from FIG. 1;

FIG. 5 depicts an example of a warning system that can be implemented in the handling machine from FIG. 1.

### DETAILED DESCRIPTION

The concept of the invention is described more completely hereinafter with reference to the appended drawings in which embodiments of the concept of the invention are shown. In the drawings the sizes and the relative sizes of the elements may be exaggerated for clarity. Similar numbers refer to similar elements in all the drawings. However this concept of the invention can be implemented in numerous different forms and should not be interpreted as being limited to the embodiments disclosed here. Instead these embodiments are proposed so that this description is complete and communicates the full extent of the concept of the invention to the person skilled in the art. For simplicity the following embodiments are described using the terminology of and with reference to the structure of a handling machine having a handling arm.

References throughout the specification to “an embodiment” indicate that a functionality, a structure or a particular feature described with reference to one embodiment is included in at least one embodiment of the present invention. Thus the expression “in one embodiment” appearing at various places throughout the specification does not necessarily refer to the same embodiment. Furthermore said functionalities, structures or particular features can be combined in any appropriate manner in one or more embodiments.

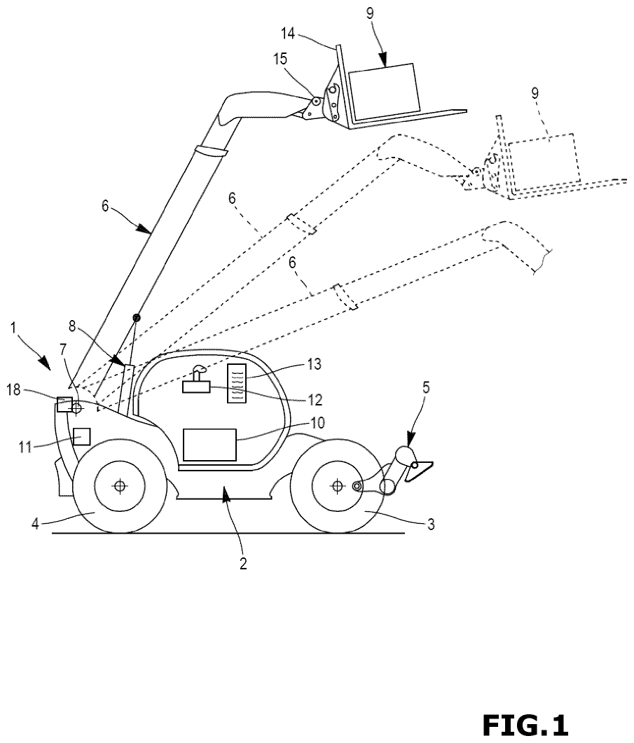

A mobile handling machine 1 that has a handling arm is represented in FIG. 1. The handling machine 1 includes a chassis 2 supported on the ground by means of a front axle 3 and a rear axle 4.

The handling machine 1 includes a handling arm 6 mounted on the chassis 2 and adapted to be oriented relative to the chassis 2 about a horizontal rotation axis 7. The handling arm 6 projects toward the front of the vehicle. In this configuration depicted in FIG. 1 the risk of tilting is present in the forward direction around the tipping axis defined by the front wheels of the vehicle.

The handling arm 6 includes a load carrier 14 articulated to the handling arm 6 by a connection 15 and configured to carry a payload 9.

In the example depicted in the figures the handling arm 6 is of the telescopic type. The handling arm 6 therefore includes at least two segments 61 and 62 deployable by means of a deployment actuator, not shown, between the at least two segments 61 and 62. Alternatively the arm can be a non-telescopic arm.

The machine includes a device for actuating the arm that includes in particular a lifting actuator, for example a hydraulic cylinder 8, which enables the handling arm 6 to be moved up and down around the horizontal axis 7 under the control of a control system.

The control system includes a control unit 10, a hydraulic circuit (not represented) and a control member 12 schematically represented in FIG. 1 that can be actuated by an operator.

The control unit 10 includes an electronic processing and/or data processing unit that includes data processing means such as a processor (microcontroller or microprocessor plus memory) enabling processing of data from sensors of the machine such as one or more extensometers 61 and a position detection system 18 described hereinafter.

Thus if it is stated that a unit or the means of a unit are configured to carry out a given operation this means that the unit contains instructions and includes the corresponding execution means that enable said operation to be carried out and/or corresponding electronic components.

In other words the functions and steps described can be implemented in the form of a computer program or by hardware components (for example programmable gate arrays). In particular the functions and steps executed by the control unit can be implemented by sets of instructions or data processing modules implemented in a processor or controller or be carried out by dedicated electronic components or FPGA or ASIC type components. It is also possible to combine computer parts and electronic parts.

The hydraulic circuit includes for example a source of hydraulic pressure and a hydraulic distributor between the source of hydraulic pressure and a control solenoid valve of the hydraulic cylinder 8. The control solenoid valve of the hydraulic cylinder 8 is controlled by the control unit 10.

The control member 12 enables manual control of the handling arm 6 to enable said handling arm 6 to be raised and lowered and deployed and retracted. The actuating member 12 can take the form of a joystick movable in different directions to control the movement of the handling arm.

Under normal circumstances the control unit 10 enables the speed of movement to be adjusted as a function of a demand for movement produced by the operator actuating the control member 12, in particular a quantitative magnitude produced by the action of the user on the control member 12 and representing a speed demanded by the user. For example the quantitative magnitude can be an angle of inclination of a pivoting lever of the control member 12 where a higher angle represents a higher speed demand and a zero inclination angle (neutral position) represents a halt demand.

As explained hereinafter the control unit 10 can decide automatically to halt or to limit the movement of the arm if given conditions are met linked to the rate of variation of an instability signal (described hereinafter) despite the demand of the operator via the control member 12.

The control unit 10 can be configured to halt or to reduce the movement of the handling arm 6 by halting or decreasing the hydraulic flowrate feeding the cylinder 8.

The automatic intervention of the control unit in the control of the arm reflects the fact that the operator has demanded a movement of the arm resulting in too high a rate of variation of instability relative to a rate of variation instability threshold value that can be predefined or defined in real time depending on the embodiment and as explained hereinafter.

By way of example, starting from the high position depicted in FIG. 1 if the operator inputs a demand for downward movement the movement is executed as long as the rate of variation of instability remains below a threshold value that can be predefined or defined in real time. The control unit 10 can instantaneously halt the movement of the arm if the rate of variation of instability threshold value is reached or exceeded.

In another embodiment the control unit 10 can command a reduction of the speed of movement of the arm if a rate of variation of instability reaches or exceeds a threshold value which in this case is preferably different from the threshold value leading to halting of the arm.

In another embodiment the control unit can determine the rate of variation of instability that will result from the demand of the operator via the control member 12 and condition execution of the demand on whether the (estimated) rate of variation of instability is below a threshold value.

The handling machine 1 also includes a position detection system 18 configured to produce a signal relating to a position of the handling arm 6, in particular an angle of inclination of the handling arm 6 relative to the chassis 2 and/or a deployed length of the handling arm 6.

The position detection system 18 includes for example a first sensor situated at the level of the axis 7 and adapted to measure the angle of inclination of the handling arm 6. The position detection system 18 also includes for example a second sensor situated at the level of the deployment cylinder and adapted to measure a travel of said deployment cylinder.

FIG. 1 shows the handling arm 6 carrying the payload 9 in a high and retracted position in continuous line and a plurality of lower and deployed positions in dashed line. In accordance with one particular aspect the arm could be lowered without deploying it. The static tipping moment exerted by the handling arm 6 in the forward direction increases as its position descends toward the horizontal. The static tipping moment also increases as the length of the handling arm 6 increases.

The handling machine 1 further includes a tipping detector 11 configured to produce a signal called the instability signal relating to a tipping moment applied to the chassis 2 about a tipping axis. Said tipping axis can be situated at the level of the front axle 3. Stabilizing feet 5 can optionally be deployed to raise the front axle 3, in which case the stabilizing feet 5 define the tipping axis.

By way of example the instability signal can be expressed as a percentage with the convention that the higher the percentage the higher the corresponding tipping moment. This percentage is determined on the basis of a calibration of the handling machine applying a zero percent instability value to a configuration of the handling machine in which the rear axle is very highly loaded and a value of 100% instability in a configuration in which the rear axle is completely relieved of any load.

In one embodiment the tipping detector 11 is arranged at the level of the cylinder 8. The tipping detector can include a pressure sensor arranged at the level of the lifting actuator, the signal relating to the tipping moment being a signal relative to a load applied at the level of the lifting actuator.

In one embodiment the tipping detector comprises a plurality of sensors for measuring a plurality of physical magnitudes relating in particular to a load carried by the handling arm and/or a position of the handling arm. In this embodiment the tipping detector is configured to determine the signal relating to a tipping moment as a function of said physical magnitudes.

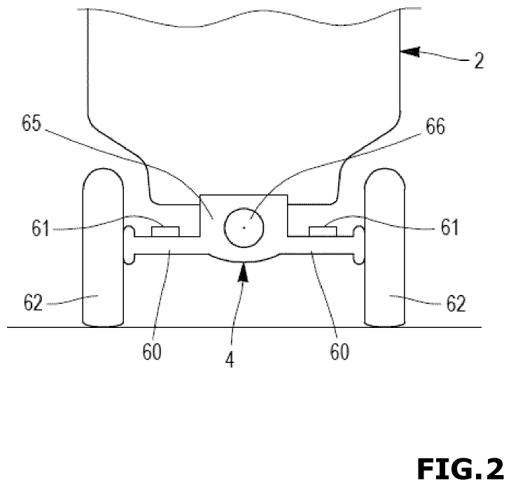

In another embodiment represented in FIG. 2 the tipping detector 11 is arranged at the level of the rear axle 4.

In FIG. 2 the rear axle 4 of the handling machine 1 includes two wheel support arms 60 carrying rear wheels 62. Each wheel support arm 60 includes an extensometer 61 configured to measure a deformation in traction of said wheel support arm 60 in a direction perpendicular to said arm 60.

Alternatively the extensometers 61 are configured to measure a deformation in bending of the wheel support arm 60, in particular a variation of the length between two spaced markers on the wheel support arm 60. The measurement signals from the extensometers 61 can be employed to form the signal indicative of the tipping moment called the instability signal, for example as the mean value of the two measurement signals. Alternatively it is possible to employ only one extensometer 61 to produce the instability signal. The rear axle 4 is preferably connected in an oscillatory manner to the chassis 2 by means of a pivot 66 with a longitudinal axis passing through a central part 65 of the axle.

In the specific situation in which the machine includes a turret enabling the arm to be oriented around a vertical axis (vertical relative to a horizontal ground bearing plane) the tipping detector 11 does not include extensometers but includes a calculation module integrated into the control unit for example to calculate the value of the instability signal from a measurement of the pressure in the cylinder and/or measurements of the machine geometry.

The control unit 10 is configured to receive the signals from the tipping detector 11. The control unit 10 is also configured to halt or to limit the movement of the handling arm 6 as a function of the rate of variation of the instability signal. The control unit 10 can include processing means configured to differentiate with respect to time the value of the instability signal and to apply to the signal digital or analog processing filters.

The control unit 10 determines the value of the rate of variation of the instability signal which is then compared to a threshold value. As described in detail hereinafter with the aid of examples of different control methods the threshold value of the rate of variation can be predefined or calculated in real time. If the value of the rate of variation of the instability signal is above or equal to said threshold value the control unit halts or restricts the speed of movement of the arm. Otherwise the speed of movement of the arm is not restricted.

In particular lowering the arm greatly affects the risk of tipping of the machine with the result that it is useful to be able to interrupt or to limit the lowering movement of the arm if the rate at which the stability of the machine is being degraded becomes too high.

The handling machine 1 advantageously includes a display 13 connected to the control unit 10. This display 13 can be configured to display a warning signal as a function of the rate of variation of the instability signal as explained hereinafter.

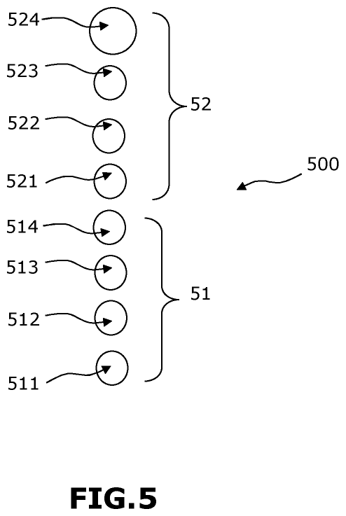

Referring to FIG. 5 the handling machine 1 includes a warning system that can be employed in the handling machine to assist the operator to control the handling arm 6 in a safe and effective manner and to enable them to obtain in return information on the risk of tipping associated with the operation in progress.

The warning system includes for example a data processing module included in the control unit and the display panel 13 or LED type indicator lamps. In one embodiment the processing module generates display or switching on commands as a function of the instability signal and the rate of variation of the instability signal to form a warning signal 500.

The warning signal 500 therefore includes a part 51 relating to the static component of the risk of tipping that is representative of the value of the instability signal and therefore of the tipping moment as such.

The four lamps 511, 512, 513, 514 at the bottom can in particular be assigned to this static component and the number of lamps switched on defined as a function of the value of the instability signal.

The warning signal 500 also includes a part relating to the dynamic component of the risk of tipping that is representative of the value of the rate of variation of the instability signal and therefore of the rate of variation of the tipping moment. The four lamps 521, 522, 523, 524 at the top can in particular be assigned to this dynamic component and the number of lamps switched on defined as a function of the value of the rate of variation of the instability signal.

The topmost lamp 524 being switched on corresponds for example to reaching or exceeding the instability signal rate of variation threshold value, which informs the operator of the halting or the reduction of the speed of movement of the handling arm.

The operator can therefore use the warning signal 500 as a visual marker and adapt their demand for movement in order to remain close to the optimum level corresponding to the lamp 523 during movement of the handling arm 6, in particular during a movement of lowering the arm the impact of which on the stability of the machine is high.

Alternatively the warning signal can be an audible signal.

### Control Method Examples

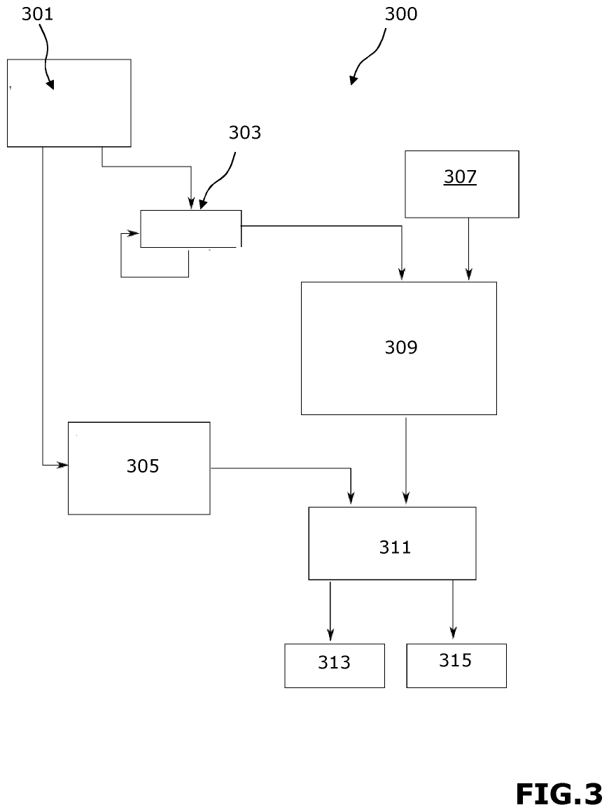

The control unit 10 can be configured to execute a method 300 of controlling the handling machine 1 represented in FIG. 3.

As explained hereinafter in order to prevent tipping of the handling machine 1 the control method 300 halts or limits the movement of the handling arm 6 on the basis of the rate of variation of the instability signal. In accordance with one particular aspect the control method is executed in real time.

In step 301 the tipping detector 11 supplies an instability signal to the control unit 10. As mentioned hereinabove the tipping detector 11 can include a sensor such as an extensometer that supplies said instability signal to the control unit. Alternatively the tipping detector can include one or more sensors associated with the handling machine and a detection module that can be part of the control unit configured to determine or to calculate the instability signal on the basis of a signal or signals supplied by said sensor or sensors. The sensor or sensors can include for example a sensor of the pressure in the cylinder 8 and a sensor of the lengthening of the handling arm.

As explained hereinafter in step 305 the control method calculates the rate VJ of variation of the instability signal. In other words the rate VJ is the rate at which the stability or instability of the handling machine changes with time.

In step 303 the value of the instability signal is compared with a predefined instability threshold value denoted J_{threshold}. By way of example this instability threshold value can be set at 85%.

If the instability signal J remains below the predefined instability threshold J_{threshold} the control method does not intervene on the movement of the handling arm then in progress.

The control method loops on this step 303 until the instability signal reaches or exceeds the predefined instability threshold.

The control method then moves on to step 309 in which a threshold value VJ_{threshold} of the rate of variation of the instability signal is calculated.

The rate of variation of the instability signal reaching or exceeding the threshold value can result from too rapid lowering of the handling arm or conversely too rapid raising of the handling arm, which could lead to a risk of tipping, whereas a movement of this type could in itself tend to improve stability.

To calculate this rate of variation threshold of the instability signal denoted VJ_{threshold} (step 309) the control unit 10 uses the value of the instability signal J at the time and takes account (step 307) of a predefined value denoted VJₘₐₓ corresponding to a maximum rate of variation of the instability signal. In other words this maximal value VJₘₐₓ of the rate of variation of the instability signal corresponds to a value beyond which it is considered that the risk of tipping of the handling machine is too high. This predefined value VJₘₐₓ can for example be set at 40% per second.

In accordance with one particular aspect said instability rate of variation threshold value denoted VJ_{threshold} is then calculated using the formula:

$${VJ}_{threshold} = ( {J}_{stat - max} - J ) * {VJ}_{max} / ( {J}_{stat - max} - {J}_{threshold} )$$

Jₛₜₐₜ₋ₘₐₓ is a predefined value corresponding to a maximal value of the instability signal beyond which it is considered that in a static configuration of the handling machine the latter will tip. The value Jₛₜₐₜ₋ₘₐₓ can for example be set at 105%. In other words Jₛₜₐₜ₋ₘₐₓ corresponds to a static stability limit of the handling machine. It must be remembered that:

J is the value of the instability signal,
J_{threshold} is the predefined threshold value of the instability signal,
VJₘₐₓ is the predefined value corresponding to a maximal rate of variation of the instability signal.

The determination of this instability rate of variation threshold value VJ_{threshold} enables monitoring of the rate VJ of variation of the instability signal with a view to reaching a stability limit of the handling machine.

After determining said value VJ_{threshold} the control method 300 tests in step 311 the rate of variation of stability denoted VJ at the time against this rate of variation threshold value VJ_{threshold}.

As mentioned hereinabove the rate of variation of stability denoted VJ can be obtained in step 305 by differentiating with respect to time the value of the instability signal J. In particular the control unit 10 can include a processing module configured to process the digital signal corresponding to the instability signal, among others, by differentiating it with respect to time.

If said rate of variation of said instability value VJ is above or equal to said rate of variation of instability threshold value the control unit 10 generates in step 313 a signal to halt the movement of the handling arm. Otherwise in step 315 the control unit 10 authorizes continued movement of the handling arm 6.

If the rate at which the stability of the handling machine is being degraded is low a maximal stability limit such as that corresponding to J_{threshold} (for example 105%) can therefore be reached, which enables a maximal reach of the handling machine to be achieved. Conversely, if the rate at which the stability of the handling machine is being degraded is high the maximal stability limit cannot be reached and the control unit 10 halts the maneuvering of the telescopic arm ahead of time and therefore with a greater safety margin compared to the maximal limit of stability that can be reached if the rate at which stability is being degraded is low.

The operator can therefore be led to control the handling arm so that the rate of variation of stability is low to reach a maximal working zone or reach with the handling arm.

To summarize, in this control method 300 depicted in FIG. 3 below a certain value of the instability signal, here 85%, the movement of the arm is not halted. Above 85% a threshold value of the rate of variation of the instability signal is calculated beyond which the control unit 10 halts movement of the arm. In particular the closer the instability signal of the handling machine approaches the maximal static cutoff limit corresponding to Jₛₜₐₜ₋ₘₐₓ (here 105%), the lower the authorized rate of variation of the instability signal.

In another embodiment the control unit can generate a signal slowing the arm instead of a signal halting the arm.

The method can in particular include a test of the rate of variation of the instability signal VJ against a first threshold value VJ_{threshold1} and a second threshold value VJ_{threshold2} so that if VJ_{threshold1}<VJ<VJ_{threshold2} the handling arm is slowed whereas if VJ>=VJ_{threshold2} the arm is halted.

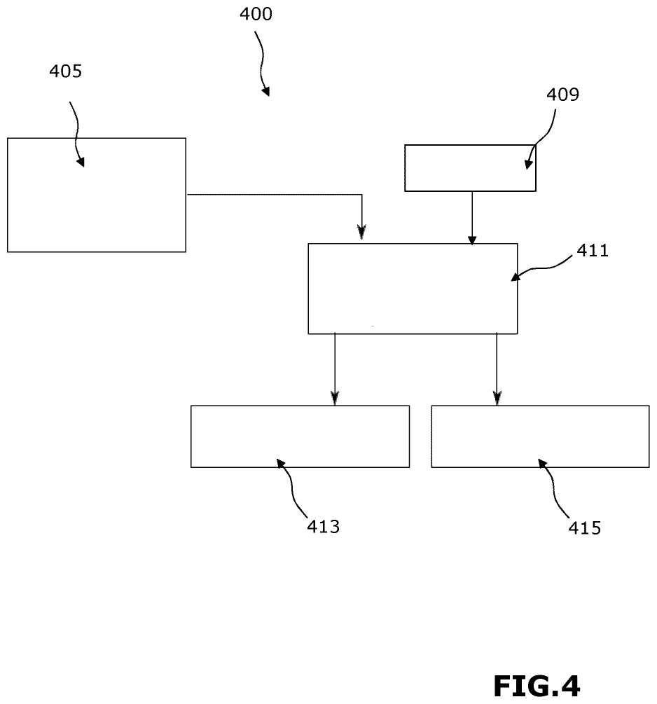

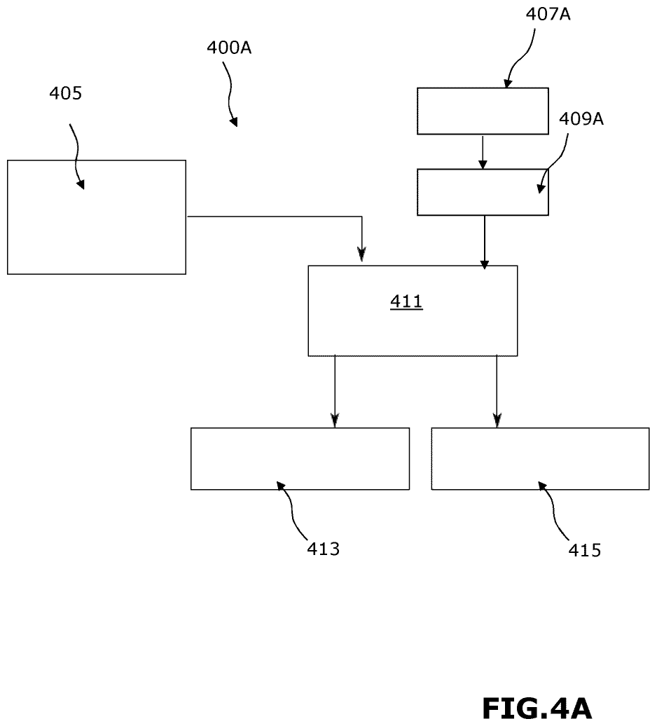

Another embodiment 400 of the control method of the handling machine 1 is represented in FIG. 4.

In this embodiment the control unit 10 calculates in step 405 the rate VJ of variation of the instability signal and compares it in step 411 with a predefined threshold value denoted VJ_{threshold_predefined} which can be read in step 409. If the rate VJ of variation of the instability signal reaches or exceeds this predefined threshold value VJ_{threshold_predefined} in step 413 the control unit 10 halts or restricts the speed of movement of the handling arm. Otherwise in step 415 the control unit 10 does not halt or restrict the speed of movement of the handling arm and therefore authorizes continued movement of the handling arm.

In other words if the rate of variation of the tipping moment exceeds a predetermined threshold the movement of the arm is halted or the speed at which the arm is being maneuvered is reduced.

Note that this embodiment of the control method enables the movement of the arm to be halted or the speed of movement of the arm to be reduced independently of any instability signal threshold, that is to say independently of whether or not the instability signal of the machine is approaching a tipping moment threshold.

In another embodiment depicted in FIG. 4A the rate of variation of the instability signal threshold beyond which operations are halted or restricted can depend on geometrical parameters of the machine and/or configuration parameters of the machine in order to adapt the behavior of the machine to its working zone. The machine geometry parameters can include the elevation angle of the handling arm and/or the extended length of the handling arm. The machine configuration parameters can include or not detection of whether the stabilizers 5 are bearing on the ground.

In the embodiment depicted in FIG. 4A that repeats the steps of the method 400 from FIG. 4 there is therefore equally proposed a control method 400A in which the threshold value denoted VJ_{angle_threshold} in this embodiment to which is compared (in step 411) the rate of variation VJ of the instability signal is defined in step 409A as a function of the angle of the manipulation arm the value of which was acquired in step 407A. This angle corresponds to the angle of the arm to the horizontal when the handling machine is on horizontal ground. As mentioned hereinabove other geometry parameters and/or configuration parameters of the handling machine can be used.

Although the invention has been described with reference to particular embodiments it is obvious that it is in no way limited to them and that it encompasses all technical equivalents and combinations of the means described if they are within the scope of the invention.

The use of the verb “to include”, “to comprise” or conjugate forms thereof does not exclude the presence of elements or steps other than those stated in a claim.

In the claims a reference sign between parentheses should not be interpreted as a limitation of the claim.

1. A handling machine (1) including:
a main body (2),
a handling arm (6) mounted on said main body (2) and rotatable relative to the main body (2) between a raised position and a lowered position,
an actuating device (8) configured to raise and to lower said handling arm (6),
a tipping detector (11) configured to produce a signal called the instability signal relating to a tipping moment applied to the main body (2) about a tipping axis of said handling machine, and
a control unit (10) configured to control the actuating device (8), characterized in that said control unit (10) is configured:
to determine the rate of variation of the value of the instability signal,
to generate a signal to halt or to slow movement of the handling arm (6) as a function of the rate of variation of said value of the instability signal and a threshold value for the rate of variation of the instability signal.

2. The handling machine (1) as claimed in claim 1 characterized in that the control unit (10) is configured to calculate the threshold value of the rate of variation of the instability signal as a function of the value of the instability signal.

3. The handling machine (1) as claimed in claim 2 characterized in that the control unit (10) is configured to calculate the threshold value of the rate of variation of the instability signal also as a function of a predefined value corresponding to a maximal rate of variation of the instability signal.

4. The handling machine (1) as claimed in claim 1 characterized in that the control unit (10) is configured to calculate the threshold value of the rate of variation of the instability signal as a function of a geometrical parameter of the handling machine such as the angle between the handling arm (6) and the plane in which the main body (2) of the handling machine (1) bears on the ground and/or a configuration parameter of the handling machine such as the configuration with the stabilizers (5) of the handling machine bearing on the ground or not.

5. The handling machine (1) as claimed in any one of claims 1 to 3
characterized in that said control unit (10) is configured to compare the value of the instability signal with a predefined instability threshold value, for example 85%,
and if the value of the instability signal is above or equal to said instability threshold value:
to compare said rate of variation of the value of the instability signal with the threshold value of the rate of variation of said instability signal, and
if said rate of variation of said value of the instability signal is above or equal to the threshold value of the rate of variation of said instability signal to generate said signal to halt or to slow the movement of the handling arm (6).

6. The handling machine (1) as claimed in any one of claims 1, 2, 3, 5 characterized in that the threshold value of the rate of variation of said instability signal denoted VJ_{threshold} is calculated using the formula:
$${VJ}_{threshold} = ( {J}_{stat \_ max} - J ) * {VJ}_{max} / ( {J}_{stat \_ max} - {J}_{threshold} )$$
J_{stat_max} being a predefined value corresponding to a maximal value of the instability signal beyond which it is considered that in a static configuration of the handling machine the latter tips,
J being the value of the instability signal,
J_{threshold} being a predefined threshold value of the instability signal,
VJₘₐₓ being a predefined value corresponding to a maximal rate of variation of the instability signal.

7. The handling machine (1) as claimed in any one of the preceding claims characterized in that said handling arm (6) is a telescopic arm deployable and retractable in a longitudinal direction of said handling arm and the actuating device (8) is also configured to deploy and to retract said handling arm (6).

8. The handling machine (1) as claimed in any one of the preceding claims characterized in that said tipping detector (11) includes at least one extensometer (61) preferably arranged on an axle (60), for example a rear axle, of the handline machine,
and said tipping detector (11) produces the instability signal as a function of the signal supplied by the extensometer (61).

9. The handling machine (1) as claimed in any one of claims 1 to 7 characterized in that the handling arm (6) can also be oriented by rotating it about an axis orthogonal to the plane in which the handling machine (1) bears on the ground.

10. The handling machine (1) as claimed in any one of the preceding claims characterized in that the handling machine (1) includes a warning system including warning elements such as indicator lamps switching on of which is a function of the rate of variation of the instability signal.

11. The handling machine (1) as claimed in any one of the preceding claims characterized in that said signal to halt or to slow movement of the handling arm (6) is a signal to halt or to slow a movement of lowering or extending the handling arm (6).

12. A method of controlling a handling machine (1) including a main body (2), a handling arm (6) mounted on said main body (2) and rotatable relative to the main body (2) between a raised position and a lowered position, and a tipping detector (11) configured to produce a signal called the instability signal relating to a tipping moment applied to the main body (2) about a tipping axis of said handling machine,
characterized in that said method includes the following steps:
determining (305; 405) the rate of variation of the value of the instability signal,
generating (313; 413) a signal to halt or to slow movement of the arm as a function of the rate of variation of said value of the instability signal (305; 405) and a threshold value for the rate of variation of the instability signal (309; 409; 409A).

13. The method as claimed in claim 12 characterized in that the rate of variation of the instability threshold value is calculated (309) as a function of the value of the instability signal.

14. The method as claimed in claim 12 characterized in that the threshold value of the rate of variation of the instability signal is calculated (409A) as a function of a geometrical parameter of the handling machine such as the angle between the handling arm (6) and the plane in which the main body (2) of the handline machine (1) bears on the ground and/or a configuration parameter of the handling machine such as the configuration with the stabilizers (5) of the handling machine bearing on the ground or not.

15. The method as claimed in any one of claims 12 to 14 characterized in that the method includes the following steps:
comparing (311; 411) said rate of variation of the value of the instability signal with the threshold value of the rate of variation of said instability signal, and
if said rate of variation of said value of the instability signal is above or equal to the threshold value of the rate of variation of said instability signal, generating (313; 413) said signal to halt or to slow the movement of the handling arm and otherwise to authorize (315; 415) continued movement of the handling arm (6).
